(19) United States
(12) Patent Application Publication
(10) Pub. No.: US 2022/0163261 A1
(43) Pub. Date: May 26, 2022

(54) Appliances and Methods for Adaptive Zonal Cooking

(71) Applicant: Haier US Appliance Solutions, Inc., Wilmington, DE (US)

(72) Inventor: Paul Bryan Cadima, Crestwood, KY (US)

(21) Appl. No.: 17/102,925

(22) Filed: Nov. 24, 2020

(51) Int. Cl. F27D 21/02; F24C 7/06; F24C 7/08; F24C 15/00; A23L 5/10; G06K 9/62

(52) U.S. Cl. CPC F27D 21/02; F24C 7/06; F24C 7/087; F24C 15/008; H04N 7/18; G06K 9/6202; F27D 2021/026; A23V 2002/00; A23L 5/15

(57) ABSTRACT

A method of operating an oven appliance including a first heat source, a second heat source, and a camera. The method including capturing a first image of a food item inside the oven, determining a characteristic of the food item, initiating a cooking cycle based on the characteristic, capturing a second image of the food item, comparing the characteristic from the first image to the second image, and directing the cooking cycle according to the change in the characteristic.

### FIELD OF THE INVENTION

The present subject matter relates generally to oven appliances, and more particularly to multi-zone oven appliances and methods for operating the same.

### BACKGROUND OF THE INVENTION

Oven appliances generally include a cabinet that defines a cooking chamber for cooking food items therein, such as by baking or broiling the food items. In order to perform the cooking operation, oven appliances typically include one or more heat sources, or heating elements, provided in various locations within the cooking chamber. These heat sources may be used together or individually to perform various specific cooking operations, such as baking, broiling, roasting, and the like.

Some oven appliances may be able to perform cooking operations on multiple food items simultaneously by allocating zones within the cooking chamber. However, current oven appliances are not able to determine, or may only approximate different cooking times or power levels of different food items placed in the cooking chamber. Accordingly, the cooking operations on multiple food items may lead to undercooked or overcooked foods, depending on what is being cooked, the state at which it is placed in the cooking chamber, and the accuracy of the cooking algorithms. Additionally, a completion time cannot currently be accurately determined, leading to constant supervision by a user to ensure food is properly cooked.

Accordingly, a method of operating an oven appliance that obviates one or more of these drawbacks would be beneficial. Particularly, a method of operating an oven appliance that is able to intelligently determine food types and doneness, and actively adjust cooking powers would be desirable.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating an oven appliance is provided. The oven appliance may include a first heat source, a second heat source, and a camera provided in a cavity of the oven appliance. The method may include capturing a first image of a food item inside the cavity using the camera, determining one or more characteristics of the food item, initiating a cooking cycle based on the one or more characteristics of the food item, capturing a second image of the food item, comparing the one or more characteristics of the food item from the first image to the second image, or directing the cooking cycle according to the comparison of the one or more characteristics.

In another exemplary aspect of the present disclosure, a cooking appliance is provided. The cooking appliance may include a cabinet, a first heat source, a second heat source, a camera, and a controller. The cabinet may define a cavity having a first heating zone and a second heating zone different from the first heating zone. The first heat source may be provided in the cavity and configured to provide heat to the first heating zone. The second heat source may be provided in the cavity and configured to provide heat to the second heating zone. The camera may be provided in the cavity. The controller may be operably connected to the first heat source, the second heat source, and the camera. The controller may be configured for capturing a first image of a food item inside the cavity using the camera, determining one or more characteristics of the food item, initiating a cooking cycle based on the one or more characteristics of the food item, capturing a second image of the food item, comparing the one or more characteristics of the food item from the first image to the second image, and directing the cooking cycle according to the comparison of the one or more characteristics.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance with the door in a closed position according to exemplary embodiments of the present disclosure.

FIG. 2 provides a front view of an interior of a cooking chamber of an exemplary oven appliance according to exemplary embodiments of the present disclosure.

FIG. 3 provides a flow chart illustrating a method of operating an oven appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

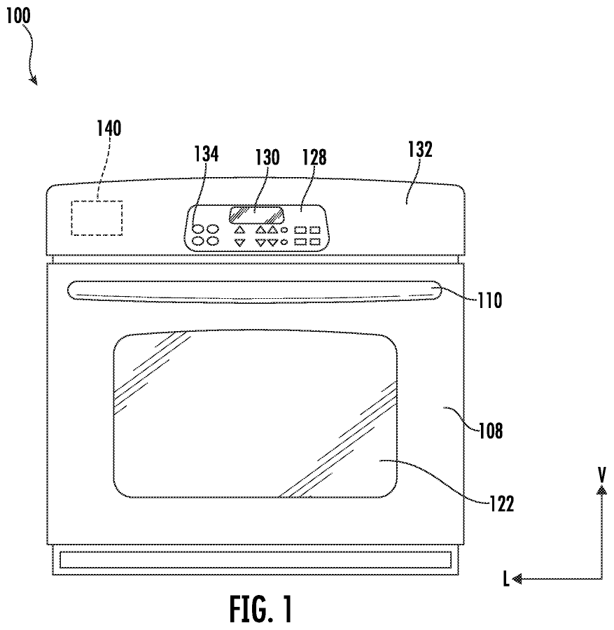

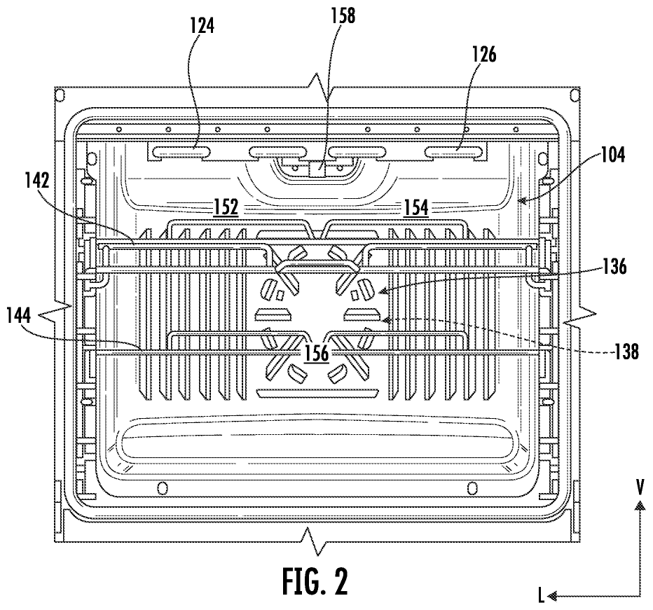

Referring to FIGS. 1 and 2, for this exemplary embodiment, oven appliance 100 may include an insulated cabinet 102 with an interior cooking chamber 104 defined by a top wall 112, a bottom wall 114, a back wall 116, and a pair of opposing side walls 118. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 may be mounted to door 108 to assist a user with opening and closing door 108. For example, a user can pull on handle 110 to open or close door 108 and access cooking chamber 104.

Oven appliance 100 may include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack may be positioned in cooking chamber 104 for the receipt of food items or utensils containing food items. For example, the cooking chamber may include a first baking rack 142 and a second baking rack 144. Each of first baking rack 142 and second baking rack may be conveniently moved into and out of cooking chamber 104 when door 108 is open (i.e., via rails provided on each of side walls 118). First baking rack 142 may be arranged above second baking rack 144 (e.g., in the vertical direction V). Thus, first baking rack 142 may be closer to top wall 112 of cabinet 102 than second baking rack 144.

One or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, oven appliance 100 includes a first top heating element 124 and a second top heating element 126, where second top heating element 126 is positioned adjacent to first top heating element 124. Other configurations with or without a wall may be used as well. For instance, a bottom heating element may be incorporated in addition or alternatively to the first and second top heating elements 124 and 126.

Oven appliance 100 may also have a convection heating element 136 and convection fan 138 positioned adjacent back wall 116 of cooking chamber 104. Convection fan 138 may be powered by a convection fan motor. Further, convection fan 138 may be a variable speed fan—meaning the speed of fan 138 may be controlled or set anywhere between and including, e.g., zero and one hundred percent (0%-100%). In certain embodiments, oven appliance 100 also includes a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 may be determined by controller 140. In addition, a sensor such as, e.g., a rotary encoder, a Hall effect sensor, or the like, may be included at the base of fan 138 to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Oven appliance 100 may include a user interface 128 having a display 130 positioned on an interface panel 132 and having a variety of user input devices, e.g., controls 134. Interface 128 may allow the user to select various options for the operation of oven 100 including, e.g., various cooking and cleaning cycles. Operation of oven appliance 100 may be regulated by a controller 140 that is operatively coupled, i.e., in communication with, user interface 128, heating elements 124, 126, 136 and other components of oven 100 as will be further described.

For example, in response to user manipulation of the user interface 128, controller 140 may operate the heating element(s). Controller 140 may receive measurements from one or more temperature sensors such as sensors described below.

Controller 140 may also provide information such as a status indicator, e.g., a temperature indication, to the user with display 130. Controller 140 may also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory may store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface with a display thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

As shown in FIG. 2, cooking chamber 104 may be divided into several distinct heating zones. For instance, cooking chamber 104 may include a first heating zone, or zone 1 152, a second heating zone, or zone 2 154, and a third heating zone, or zone 3 156. It should be understood that any suitable number of heating zones may be incorporated into cooking chamber 104, including more or less than three heating zones. Each of the heating zones may be spaced apart from one another (e.g., along the vertical direction V, the lateral direction L, and/or transverse direction T). In other words, zone 1 152 may be spaced apart from zone 2 154 and zone 3 156, etc. Accordingly, each heating zone may be controlled separately from one another (e.g., to or at a different temperature or power level, using a different criterion, or using a different heating cycle).

In one example, first heating zone 152 corresponds to first top heating element 124. In other words, first top heating element 124 may be configured to provide heat to the first heating zone 152. First top heating element 124 may be located predominantly to a first side of cooking chamber 104 in the lateral direction L (e.g., proximal to the first side, distal to an opposite second side, and/or otherwise corresponding to first heating zone 152). Accordingly, first top heating element 124 may provide heat predominantly to first heating zone 152 while having minimal heating impact on second heating zone 154 and third heating zone 156. First heating zone 152 may be positioned at or near a top of cooking chamber 104. For example, first heating zone 152 may correspond to first baking rack 142 (e.g., a first half thereof). Accordingly, first heating zone 152 may be a first broil zone.

Similarly, second heating zone 154 may correspond to second top heating element 126. In other words, second top heating element 126 may be configured to provide heat to the second heating zone 154. Second top heating element 126 may be located predominantly to the second side of cooking chamber 104 in the lateral direction L (e.g., proximal to the second side, distal to the first side, and/or otherwise corresponding to second heating zone 154). Accordingly, second top heating element 126 may provide heat predominantly to second heating zone 154 while having minimal heating impact on first heating zone 152 and third heating zone 156. Second heating zone 154 may be positioned at or near a top of cooking chamber 104. Additionally or alternatively, second heating zone 154 may be adjacent to first heating zone 152 in the lateral direction L. For example, second heating zone 154 may correspond to first baking rack 142 (e.g., a second half thereof). Accordingly, second heating zone 154 may be a second broil zone. In some embodiments, second top heating element 126 does not overlap with first heating zone 152 (e.g., in a vertical direction). For example, first top heating element 124 is positioned vertically over first heating zone 154 and second heating element 126 is positioned vertically over second heating zone 156.

Third heating zone 156 may be defined spaced apart from first heating zone 152 and second heating zone 154. For instance, third heating zone 156 may be located beneath first heating zone 152 and second heating zone 154 in the vertical direction V, as shown in FIG. 2. In some embodiments, third heating zone 156 is a baking zone. Accordingly, third heating zone 156 may receive heat primarily from convection heating element 136 (or a bottom heating element). However, this embodiment is not limited, and third heating zone 156 may receive heat from a bottom heating element, a side heating element, or a combination of available heating elements.

Each of the first heating zone 152, second heating zone 154, and third heating zone 156 may be controlled according to an individual cooking cycle. For example, each of the first heating zone 152, second heating zone 154, and third heating zone 156 may be controlled according to a category or type of food identified in each zone (e.g., protein, starch, vegetable, etc.). The individual cooking cycles may be classified as power levels, and may be the same, or, in some instances, different from each other. For example, a cooking cycle or power level for the first heating zone 152 may be a broil cycle for a specific casserole dish placed in the first heating zone 152. Simultaneously, a cooking cycle or power level for the third heating zone 156 may be a low temperature roast cycle for a meat dish. Advantageously, since each of the first heating zone 152, second heating zone 154, and third heating zone 156 may be heated by different heating elements, several cooking operations (i.e., several power levels for different food types) involving different parameters may be performed at the same time, as will be explained below.

A camera 158 may be provided within cooking chamber 104. Generally, camera 158 may be a video camera or a digital camera with an electronic image sensor [e.g., a charge coupled device (CCD) or a CMOS sensor]. When assembled, camera 158 is in communication (e.g., electric or wireless communication) with controller 140 such that controller 140 may receive a signal from camera 158 corresponding to the image captured by camera 158. Camera 158 may be configured to capture images of cooking chamber 104 (e.g., an interior of cabinet 102). For instance, camera 158 may capture images of food items placed in each of first heating zone 152, second heating zone 154, and/or third heating zone 156. Camera 158 may be located in any suitable location within cooking chamber 104, such that each of first heating zone 152, second heating zone 154, and/or third heating zone 156 are visible to camera 158. For example, as shown in FIG. 2, camera 158 may be located at or near a top of cooking chamber 104 in the vertical direction V (e.g., between the first and second heating elements 124, 126 along the lateral direction L). Additionally or alternatively, camera 158 may be located at or near a center of cooking chamber 104 in the lateral direction L. The specific location of camera 158 is not limited, however, and one of ordinary skill in the art would appreciate multiple potential locations for camera 158.

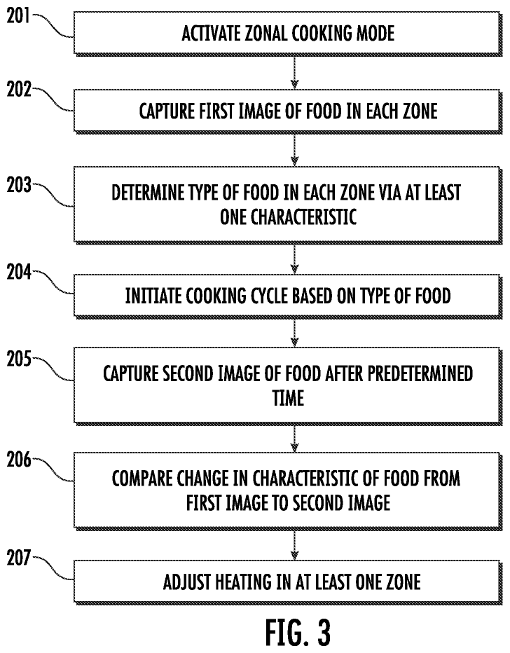

FIG. 3 is a flowchart describing a method 200 of operating a cooking appliance. For example, the method 200 described herein with respect to FIG. 3 may be used to operate the cooking appliance described above with respect to FIGS. 1 and 2. Additionally or alternatively, the method 200 described herein with respect to FIG. 3 may be used to operate other suitable cooking appliances.

Generally, a user may begin a cooking process by selecting one or more food items to place in a cooking chamber of an oven appliance (e.g., cooking chamber 104 of oven appliance 100). For example, a user may place a first food item requiring a first cooking cycle (or heat level) into a first heating zone (e.g., first heating zone 152), and a second food item requiring a second cooking cycle (or heat level) into a second heating zone (e.g., second heating zone 154) prior to the below described steps of the method 200. In some embodiments, a user places a third food item requiring a third cooking cycle (or heat level) into a third heating zone. Nonetheless, as would be understood in light of the present disclosure, the number of heating zones and food items may vary according to specific applications, and the disclosure is not limited to two items.

At step 201, the method 200 includes receiving a zonal cooking input to initiate a zonal cooking mode (e.g., in response to a user's selection at the user interface). The zonal cooking mode may include a first cooking cycle or operation for the first heating zone and a second cooking cycle or operation for the second heating zone. Additionally or alternatively, the zonal cooking mode may include a third cooking cycle or operation for a third heating zone. Upon activating the zonal cooking mode, the method may proceed to step 202.

At step 202, the method 200 includes capturing a first image of the cooking chamber using the camera. Within the cooking chamber and the line of sight of the camera, one or more food items (e.g., first food item) may be positioned. Thus, camera within the cooking chamber may capture a first image of the food item or items placed in the cooking chamber. In detail, the camera may capture an image of a first food item placed in the first heating zone, an image of a second food item placed in the second heating zone, and/or an image of a third food item placed in the third heating zone. In some embodiments, a single image captured by the camera includes each of the first, second, and third food items. Additionally or alternatively, the camera may capture separate images for each of the first, second, and third food items. The camera may then send the captured image or images to a controller.

At step 203, the method 200 includes determining the types of food items within the heating zones. In particular, the controller may determine a type of food in each zone. For instance, the controller may analyze the image of the first food item in the first heating zone and extract one or more characteristics relating to the food item (e.g., color, texture, consistency, etc.). Using the extracted characteristic(s), the controller may reference a programmed formula, chart, or table. As an example, the controller may consult a lookup table stored within the oven appliance to determine what type of food is provided in the first heating zone based on a comparison with the extracted characteristic(s) of the first food item. For instance, a qualitative attribute of a particular characteristic may be assigned a quantitative value within the lookup table (e.g., a level of brownness from 1 to 5). Similarly, the controller may analyze the image of the second food item in the second heating zone and extract one or more characteristics relating to the food item (e.g., color, texture, consistency, etc.). Additionally or alternatively, the camera may detect various optical characteristics, such as wavelength bands, infrared emittance, and the like. Using the extracted characteristic(s), the controller may reference a programmed formula, chart, or table. As an example, the controller may consult the lookup table stored within the oven appliance to determine what type of food is provided in the second heating zone based on a comparison with the extracted characteristic(s) of the second food item. For instance, a qualitative attribute of a particular characteristic may be assigned a quantitative value within the lookup table (e.g., a level of brownness from 1 to 5, a food volume estimation, etc.).

In some embodiments, the controller determines a type of a first food provided in the first heating zone and a type of a second food provided in the second heating zone simultaneously. Additionally or alternatively, the controller may determine a type of a third food provided in a third heating zone.

Separate from or in addition to the determination of the types of food items, the controller may estimate a total cooking time (or an appropriate heating schedule) for the first food item and/or the second food item, or in some instances, the first heating zone and the second heating zone. For example, in the lookup table, the controller may have predetermined times programmed in relating to the quantitative value of the characteristic. After determining the quantitative value (e.g., the level of doneness or amount cooked), the controller may select an amount of time remaining to complete cooking in each zone according to the quantitative value.

At step 204, the method 200 includes initiating a cooking cycle based on the type of food detected. In detail, after determining the type of the first food provided in the first heating zone, the controller may initiate a particular cooking cycle related to the particular type of food. For example, the controller may activate the first heat source (e.g., first top heating element 124) to provide heat to the first food and activate the second heat source (e.g., second top heating element 126) to provide heat to the second food. The first heat source may be operated at a first power level (i.e., to provide a first controlled amount of heat). The second heat source may be operated at a second power level (i.e., to provide a second controlled amount of heat). The first power level and the second power level may be different from each other. In one embodiment, the first power level is greater than the second power level. It should be understood that the first and second power levels may vary depending on the type of food sensed.

The cooking cycle may include activation and monitoring of a heat source corresponding to the first heating zone (e.g., first top heating element 124). For example, a heat source (e.g., first top heating element 124) may be activated via the controller (i.e., by running electricity through one or more heating coils). Additionally or alternatively, the controller may monitor the electrical output or heat output to maintain a specific cooking temperature or rate. Thus, the first food item provided in the first heating zone may be cooked according to a specific cooking cycle relevant to the particularly identified food. Similarly, after determining the type of the second food provided in the second heating zone, the controller may initiate a particular cooking cycle related to the particular type of food. The cooking cycle may include activation and monitoring of a heat source corresponding to the second heating zone (e.g., second top heating element 126). Thus, the second food item provided in the second heating zone may be cooked according to a specific cooking cycle relevant to the particularly identified food.

At step 205, the method 200 includes capturing a second image of the food items. For instance, the second image may be captured after a predetermined amount of time has elapsed in the cooking cycle(s). In detail, after the cooking cycle or cycles have run for a predetermined amount of time, the camera may capture a second image of the cooking chamber (e.g., including the first food item and the second food item). The predetermined time may be set by a user or may be preset during manufacturing. The predetermined time may be 20 minutes, may be 10 minutes, may be 5 minutes, may be 2 minutes, etc. Additionally or alternatively, the camera may capture a plurality of sequential images at a predetermined frequency (i.e., separated by the predetermined time). Each image captured by the camera may be transmitted to the controller.

At step 206, the method 200 includes comparing the one or more characteristics of the food item from the first image to the second image. For instance, 206 may include comparing a change in the one or more characteristics of the food item from the first image to the second image. In detail, the controller may compare the food item (e.g., the first food item in the first heating zone or the second food item in the second heating zone) in the first image to the food item in the second image. For example, the method compares a change in color of the food item between the first image and the second image, and determines the assigned quantitative value to the determined qualitative attribute. The method may consult stored data pertaining to the particular food item (i.e., the type of food determined in step 203) and analyze a cooking progress based on the change in the one or more characteristics.

In the case of a plurality of sequential images being captured by the camera, the controller may perform an analysis of two sequential images (e.g., between a first image and a second image, between the second image and a third image, etc.). For example, the controller may compare a characteristic (e.g., brownness) from the first image to the same characteristic from the second image. The controller may differentiate the qualitative assessment between the characteristic in the two images and determine the quantitative value. According to each analysis, the controller may monitor a cooking progress for each food item in each heating zone. Advantageously, a more accurate cooking time and cooking doneness may be obtained.

At step 207, the method 200 includes adjusting the cooking cycle according comparison at 206. If a change is detected between the first image and the second image, the adjustment may be made according to the change in the one or more characteristics. In detail, after comparing the first image to the second image and analyzing the cooking progress for the food item, the controller may adjust an output from the heat source associated with the particular food item being analyzed. For example, the controller may compare a characteristic (e.g., color) of the food item from the first image to the characteristic (e.g., color) of the food item from the second image and determine that the cooking cycle is nearing completion. In another example, the controller may calculate the amount of time the food item has been cooking and determine that the cooking cycle is nearing completion. As mentioned previously, the quantitative value assigned with the determined qualitative attribute is then determined. Accordingly, the controller may reduce the heat output from the heat source (e.g., first top heating element 124) according to the quantitative value.

In an embodiment where two different food types are being cooked in two different zones, the controller may further compare an estimated cooking time remaining for each of the first food in the first heating zone and the second food in the second heating zone. For example, the controller compares a characteristic (e.g., color) of the first food in the first image to the characteristic (e.g., color) of the first food in the second image and determine that there is a first timespan (e.g., 30 minutes) left until the first food is fully cooked. In detail, the controller may analyze the characteristic and compare the analyzed characteristic to one or more programmed levels of the characteristic stored in a lookup table within the oven appliance. Simultaneously, the controller may compare a characteristic (e.g., color) of the second food in the first image to the characteristic (e.g., color) of the second food in the second image and determine that there is a discrete second timespan (e.g., 20 minutes) left until the second food is fully cooked. In detail, the controller may analyze the characteristic and compare the analyzed characteristic to one or more programmed levels of the characteristic stored in a lookup table within the oven appliance. In some embodiments, the controller then adjusts the cooking cycle of the second food such that the first food and the second food will finish cooking at the same time (e.g., at the expiration of the longer of the first and second timespans, such as in 30 minutes). For instance, the controller may reduce the output (e.g., by varying the input power, duty cycle, heat source temperature, etc.) of the second heat source (e.g., second top heating element 126) such that the cooking time for the second food is the same as the cooking time for the first food.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the oven appliance comprising a first heat source, a second heat source, and a camera provided in a cavity of the oven appliance, the method comprising:
capturing a first image of a food item inside the cavity using the camera;
determining one or more characteristics of the food item;
initiating a cooking cycle based on the one or more characteristics of the food item;
capturing a second image of the food item;
comparing the one or more characteristics of the food item from the first image to the second image; and
directing the cooking cycle according to the comparison of the one or more characteristics.

2. The method of claim 1, wherein the cavity of the oven appliance comprises a first heating zone and a second heating zone spaced apart from the first heating zone, and wherein the first heat source is configured to provide heat to the first heating zone and the second heat source is configured to provide heat to the second heating zone.

3. The method of claim 2, wherein the determining one or more characteristics of the food item comprises
determining one or more characteristics of a first discrete food item located in the first heating zone; and
determining one or more characteristics of a second discrete food item located in the second heating zone.

4. The method of claim 3, further comprising:
determining a type of the first discrete food item in the first heating zone via the image captured by the camera; and
determining a type of the second discrete food item in the second heating zone via the image captured by the camera, and
wherein initiating the cooking cycle comprises
activating the first heat source according to the first food type, and
activating the second heat source according to the second food type.

5. The method of claim 4, wherein activating the first heat source according to the first food type comprises operating the first heat source at a first power level, and wherein activating the second heat source according to the second food type comprises operating the second heat source at a second power level, the second power level being different from the first power level.

6. The method of claim 5, wherein the directing the cooking cycle comprises adjusting activation of the first heat source and adjusting activation of the second heat source.

7. The method of claim 6, wherein the directing the cooking cycle comprises adjusting the first power level of the first heat source and adjusting the second power level of the second heat source.

8. The method of claim 3, further comprising:
calculating an estimated first time for reaching a cooked state of the first discrete food item;
calculating an estimated second time for reaching a cooked state of the second discrete food item;
determining a heat corrective to simultaneously reach the cooked state of the first discrete food item and the second discrete food item based on the estimated first time and the estimated second time; and
directing the first and second heat sources according to the determined heat corrective.

9. The method of claim 8, wherein directing the first and second heat sources according to the determined heat corrective comprises adjusting a power level of the first heat source or adjusting a power level of the second heat source.

10. The method of claim 2, further comprising:
a third heating zone spaced apart from the first heating zone and the second heating zone; and
a third heat source configured to provide heat to the third heating zone.

11. The method of claim 1, further comprising:
capturing a plurality of sequential images at a predetermined frequency, the first image being one image of the plurality of sequential images; and
comparing the one or more characteristics of the food item between each sequential pair of the plurality of sequential images.

12. The method of claim 11, further comprising adjusting an output of the first or second heat source according to the comparison of the one or more characteristics of the food item between one or more sequential pair of the plurality of sequential images.

13. The method of claim 1, wherein the one or more characteristics comprise a temperature, a color, a size, and a moisture content.

14. A cooking appliance, comprising:
a cabinet defining a cavity having a first heating zone and a second heating zone different from the first heating zone;
a first heat source disposed in the cavity and configured to provide heat to the first heating zone;
a second heat source disposed in the cavity and configured to provide heat to the second heating zone;
a camera disposed in the cavity; and
a controller operably connected to the first heat source, the second heat source, and the camera, the controller configured for
capturing a first image of a food item inside the cavity using the camera,
determining one or more characteristics of the food item,
initiating a cooking cycle based on the one or more characteristics of the food item,
capturing a second image of the food item, comparing the one or more characteristics of the food item from the first image to the second image, and
directing the cooking cycle according to the comparison of the one or more characteristics.

15. The cooking appliance of claim 14, wherein the food item comprises a first food item located in the first heating zone and a second food item located in the second heating zone, the second food item being different from the first food item.

16. The cooking appliance of claim 15, wherein the controller is further configured for:
determining a type of the first food item in the first heating zone via the image captured by the camera; and
determining a type of the second food item in the second heating zone via the image captured by the camera, and
wherein initiating the cooking cycle comprises
activating the first heat source according to the first food type, and
activating the second heat source according to the second food type.

17. The cooking appliance of claim 16, wherein activating the first heat source according to the first food type comprises operating the first heat source at a first power level, and wherein activating the second heat source according to the second food type comprises operating the second heat source at a second power level, the second power level being different from the first power level.

18. The cooking appliance of claim 17, wherein the controller is further configured for:
calculating an estimated first time for reaching a cooked state of the first discrete food item;
calculating an estimated second time for reaching a cooked state of the second discrete food item;
determining a heat corrective to simultaneously reach the cooked state of the first discrete food item and the second discrete food item based on the estimated first time and the estimated second time; and
directing the first and second heat sources according to the determined heat corrective.

19. The cooking appliance of claim 14, further comprising:
a third heating zone spaced apart from the first heating zone and the second heating zone; and
a third heat source configured to provide heat to the third heating zone.
